(19) United States
(12) Patent Application Publication
(10) Pub. No.: US 2026/0161486 A1
(43) Pub. Date: Jun. 11, 2026

(54) SELF-CORRECTING RUNTIME ENGINE USING DISTRIBUTED ARTIFICIAL INTELLIGENCE (AI) AGENTS

(71) Applicant: BOOMI, LP, Conshohocken, PA (US)

(72) Inventor: Juan Carlos Martin Echevarria Morera, Arlington, VA (US)

(21) Appl. No.: 18/977,284

(22) Filed: Dec. 11, 2024

(51) Int. Cl. G06F 9/54; G06F 16/22

(52) U.S. Cl. CPC G06F 9/542; G06F 16/22

(57) ABSTRACT

In an Integration Platform as a Service (iPaaS) platform, integration processes may be executed in runtime engines. During execution, runtime engines produce runtime events, which can represent errors that must be resolved by human users. Disclosed embodiments enables these runtime engines to be self-correcting, using distributed artificial intelligence (AI) agents. In particular, a support agent may determine whether or not there is a known resolution to a runtime event. If not, the support agent may collaborate with a plurality of distributed engineer agents, within separate knowledge domains, to identify, select, and execute candidate resolutions until the runtime event is resolved. Successful resolutions may be fed back into a knowledge base for continual and autonomous improvement.

### BACKGROUND

### Field of the Invention

The embodiments described herein are generally directed to runtime environments, and, more particularly, to the autonomous correction of a runtime engine using distributed artificial intelligence (AI) agents.

### Description of the Related Art

Integration Platform as a Service (iPaaS) enables the integration of applications and data. The iPaaS platform provided by Boomi® of Conshohocken, Pennsylvania, enables users to construct integration processes from pre-built steps, visually represented as “shapes,” which each has a set of configuration properties. Each step dictates how an integration process retrieves data, manipulates data, routes data, sends data, and/or the like. These steps can be connected together in endless combinations to build simple to very complex integration processes.

Once deployed, these integration processes may be executed in a lightweight, dynamic runtime engine (e.g., the Boomi Atom™). The runtime engine may contain all of the components required to run the integration processes from end to end, including connectors, transformation rules, decision handling, processing logic, and the like. A runtime engine may be executed locally or remotely (e.g., in the cloud), depending on the particular application.

Issues may arise during execution of the runtime engine. For example, one or more integration processes within the runtime engine may generate an error, warning, or other abnormal runtime event. An abnormal runtime event may disrupt an integration process (e.g., prevent further execution of the integration process) or otherwise hinder the operation of an integration process (e.g., result in abnormal operation of the integration process, reduce performance of the integration process, etc.).

In many cases, a small degree of artificial intelligence is sufficient to autonomously resolve the issue. As an example, a common reason for execution failures, encountered by users of the Boomi® platform, is the runtime engine reaching a maximum worker limit. A worker (e.g., Boomi Atom Worker™) is responsible for executing an integration process within the runtime engine. The number of workers can be scaled up or down to dynamically and elastically balance the load on the runtime engine. The runtime engine may have a configurable worker limit, which limits the total number of workers that may exist simultaneously. Thus, such execution failures may be prevented by simply increasing this worker limit. In other cases, a larger degree of artificial intelligence may be needed.

### SUMMARY

Accordingly, systems, methods, and non-transitory computer-readable media are disclosed for the autonomous correction of a runtime engine using distributed artificial intelligence (AI) agents.

In an embodiment, a method comprises using at least one hardware processor to, by a support agent, for each of a plurality of runtime events, in an event queue, for at least one runtime engine, in real time: determine that the runtime event is not associated with a known resolution in a knowledge base; send a representation of the runtime event to each of a plurality of engineer agents, wherein each of the plurality of engineer agents is configured to apply a different knowledge domain to the runtime event than any other one of the plurality of engineer agents, to produce a candidate resolution; receive the candidate resolutions from the plurality of engineer agents; and in each of one or more iterations, select one resolution from the candidate resolutions, initiate execution of the selected resolution, determine whether or not the executed resolution resolved the runtime event, when determining that the executed resolution did not resolve the runtime event, add another iteration to the one or more iterations, and when determining that the executed resolution resolved the runtime event, add an association between the executed resolution and the runtime event to the knowledge base, and end the one or more iterations.

The knowledge base may comprise a vector database, wherein the vector database comprises a plurality of embedding vectors, and wherein each of the plurality of embedding vectors represents a position of a past runtime event in a multi-dimensional vector space. Each of the plurality of embedding vectors may be associated with a past resolution. Determining that the runtime event is not associated with a known resolution in the knowledge base may comprise: deriving a feature vector from the runtime event; and searching the vector database for one or more of the plurality of embedding vectors that match the feature vector according to a similarity metric. The knowledge base may further comprise a generative model, wherein determining that the runtime event is not associated with a known resolution in the knowledge base further comprises: generating a prompt based on a result of the search of the vector database; inputting the prompt to the generative model to produce a response; and determining that the runtime event is not associated with a known resolution based on the response.

Each of one or more of the plurality of engineer agents may be associated with a domain-specific knowledge base that is specific to the knowledge domain of that engineer agent, wherein each of the one or more engineer agents produces the candidate resolution based on the domain-specific knowledge base. The domain-specific knowledge base associated with each of the one or more engineer agents may comprise a vector database, wherein the vector database comprises a plurality of embedding vectors, and wherein each of the plurality of embedding vectors represents a position of a past runtime event in a multi-dimensional vector space. Each of the plurality of embedding vectors may be associated with a past resolution.

Producing the candidate resolution may comprise: searching the vector database for one or more of the plurality of embedding vectors that match a feature vector, derived from the runtime event, according to a similarity metric; and retrieving the past resolution associated with each matching one of the plurality of embedding vectors. The domain-specific knowledge base associated with each of the one or more engineer agents further may comprise a generative model, wherein producing the candidate resolution further comprises: generating a prompt based on any past resolution that was retrieved; inputting the prompt to the generative model to produce a response; and determining the candidate resolution based on the response. The generative model, in the domain-specific knowledge base associated with each of the one or more engineer agents, may be fine-tuned for the knowledge domain of that engineer agent. The response may identify the candidate resolution.

The knowledge base may comprise a general knowledge base that is separate from each domain-specific knowledge base, wherein determining that the runtime event is not associated with the known resolution in the knowledge base consists of determining that the runtime event is not associated with the known resolution in the general knowledge base. Adding the association between the executed resolution and the runtime event to the knowledge base may comprise adding the association to the general knowledge base. Adding the association between the executed resolution and the runtime event to the knowledge base may comprise adding the association to the domain-specific knowledge base associated with engineer agent that produced the candidate resolution that was selected for execution.

The support agent may execute the selected resolution. Alternatively, the engineer agent, that produced the candidate resolution that was selected, may execute the selected resolution. The one or more iterations may be a plurality of iterations.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein may be implemented, according to an embodiment;

FIG. 2 illustrates an example processing system, by which one or more of the processes described herein may be executed, according to an embodiment;

FIG. 3 illustrates an example data flow for a self-correcting runtime engine, according to an embodiment; and

FIG. 4 illustrates an example process for a support agent for a runtime engine, according to an embodiment.

### DETAILED DESCRIPTION

In an embodiment, systems, methods, and non-transitory computer-readable media are disclosed for the autonomous correction of a runtime engine using distributed artificial intelligence (AI) agents. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. Infrastructure

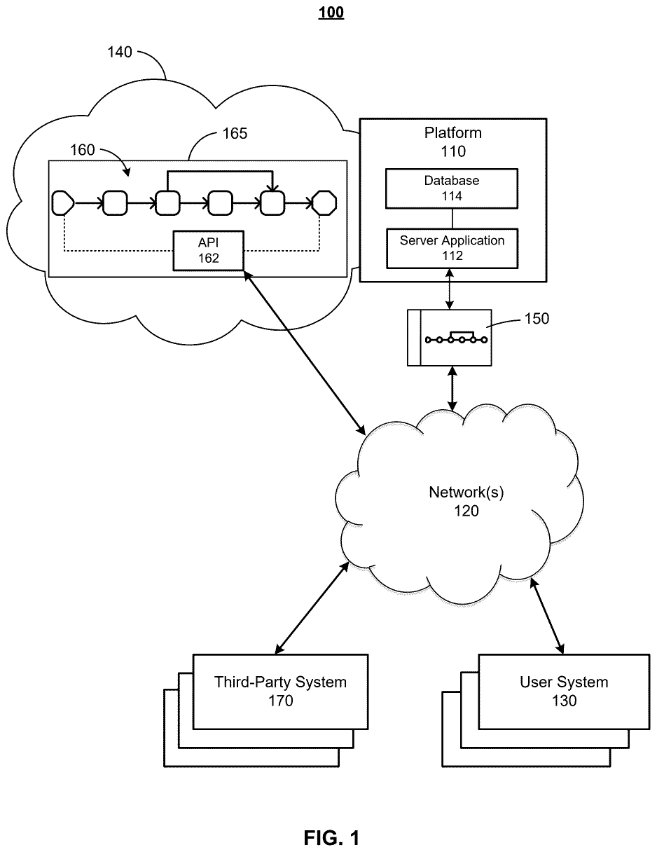

FIG. 1 illustrates an example infrastructure 100, in which one or more of the processes described herein may be implemented, according to an embodiment. Infrastructure 100 may comprise a platform 110 which hosts and/or executes one or more of the disclosed processes, which may be implemented in software and/or hardware. In particular, platform 110 may execute a server application 112 and/or host a database 114 that may store data used by server application 112. Platform 110 may comprise dedicated servers, or may instead be implemented in a computing cloud, in which the resources of one or more servers are dynamically and elastically allocated to multiple tenants based on demand. In either case, the servers may be collocated and/or geographically distributed.

Platform 110 may be communicatively connected to one or more networks 120. Network(s) 120 enable communication between platform 110 and user system(s) 130. Network(s) 120 may comprise the Internet, and communication through network(s) 120 may utilize standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to a plurality of user systems 130 through a single set of network(s) 120, it should be understood that platform 110 may be connected to different user systems 130 via different sets of one or more networks. For example, platform 110 may be connected to a subset of user systems 130 via the Internet, but may be connected to another subset of user systems 130 via an intranet.

While only a few user systems 130 are illustrated, it should be understood that platform 110 may be communicatively connected to any number of user system(s) 130 via network(s) 120. User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. However, it is generally contemplated that a user system 130 would be the personal or professional workstation of an integration developer that has a user account for accessing server application 112 on platform 110. It should be understood that the integration developer may be anywhere from a novice, with little to no prior experience in integration development, to an expert, with many years of experience in integration development. When platform 110 is an iPaaS platform, each user account may be associated with an overarching organizational account for managing an integration platform on the iPaaS platform.

Server application 112 may manage an integration environment 140. In particular, server application 112 may provide a user interface 150 and backend functionality, including one or more of the processes disclosed herein, to enable users, via user systems 130, to construct, develop, modify, save, delete, test, deploy, un-deploy, and/or otherwise manage integration processes 160 within integration environment 140. User interface 150 may comprise a graphical user interface that implements a low-code environment, including potentially a no-code environment, in which users may construct integration processes 160.

The user of a user system 130 may authenticate with platform 110 using standard authentication means, to access server application 112 in accordance with permissions or roles of the associated user account. The user may then interact with server application 112 to manage one or more integration processes 160, for example, within a larger integration platform within integration environment 140. It should be understood that multiple users, on multiple user systems 130, may manage the same integration process(es) 160 and/or different integration processes 160 in this manner, according to the permissions or roles of their associated user accounts.

Although only a single integration process 160 is illustrated, it should be understood that, in reality, integration environment 140 may comprise any number of integration processes 160. In an embodiment, integration environment 140 supports integration platform as a service (iPaaS). In this case, integration environment 140 may comprise one or a plurality of integration platforms that each comprises one or a plurality of integration processes 160. Each integration platform may be associated with an organization, which may be associated with one or more user accounts by which respective user(s) manage the organization's integration platform, including the various integration process(es) 160.

An integration process 160 may represent a transaction involving the integration of data between two or more systems, and may comprise a series of elements that specify logic and transformation requirements for the data to be integrated. Each element, which may also be referred to herein as a “step” and have a visual representation referred to herein as a “shape,” may transform, route, and/or otherwise manipulate data to attain an end result from input data. For example, a basic integration process 160 may receive data from one or more data sources (e.g., via an application programming interface 162 of the integration process 160), manipulate the received data in a specified manner (e.g., including mapping, analyzing, normalizing, altering, updating, enhancing, and/or augmenting the received data), and send the manipulated data to one or more specified destinations (e.g., via an application programming interface of each destination). An integration process 160 may represent a business workflow or a portion of a business workflow or a transaction-level interface between two systems, and comprise, as one or more elements, software modules that process data to implement the business workflow or interface. A business workflow may comprise any myriad of workflows of which an organization may repetitively have need. For example, a business workflow may comprise, without limitation, procurement of parts or materials, manufacturing a product, selling a product, shipping a product, ordering a product, billing, managing inventory or assets, providing customer service, ensuring information security, marketing, onboarding or offboarding an employee, assessing risk, obtaining regulatory approval, reconciling data, auditing data, providing information technology services, and/or any other workflow that an organization may implement in software.

Each integration process 160, when deployed, may be executed within a runtime engine 165. For example, runtime engine 165 may comprise one or a plurality of workers (not shown) that execute individual integration processes 160. Runtime engine 165 may contain all of the components required to run integration processes 160 from end to end, including connectors, transformation rules, decision handling, processing logic, and the like. Runtime engine 165 may be executed in integration environment 140, which may be a cloud-computing environment. Alternatively, runtime engine 165 may be executed locally, for example, on a user system 130, which may be an on-premises server system.

Each integration process 160, when deployed, may be communicatively coupled to network(s) 120. For example, each integration process 160 may comprise an application programming interface (API) 162 that enables clients to access integration process 160 via network(s) 120. A client may push data to integration process 160 through application programming interface 162, and/or pull data from integration process 160 through application programming interface 162.

One or more third-party systems 170 may be communicatively connected to network(s) 120, such that each third-party system 170 may communicate with an integration process 160 in integration environment 140 via application programming interface 162. Third-party system 170 may host and/or execute a software application that pushes data to integration process 160 and/or pulls data from integration process 160, via application programming interface 162. Additionally or alternatively, an integration process 160 may push data to a software application on third-party system 170 and/or pull data from a software application on third-party system 170, via an application programming interface of the third-party system 170. Thus, third-party system 170 may be a client or consumer of one or more integration processes 160, a data source for one or more integration processes 160, and/or the like. As examples, the software application on third-party system 170 may comprise, without limitation, enterprise resource planning (ERP) software, customer relationship management (CRM) software, accounting software, and/or the like.

### 2. Example Processing System

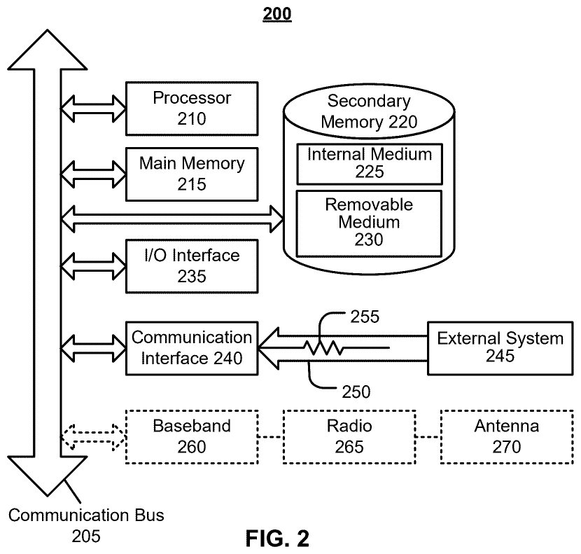

FIG. 2 illustrates an example processing system, by which one or more of the processes described herein may be executed, according to an embodiment. For example, system 200 may be used to store and/or execute server application 112, and/or may represent components of platform 110, user system(s) 130, third-party system 170, and/or other processing devices described herein. System 200 can be any processor-enabled device (e.g., server, personal computer, etc.) that is capable of wired or wireless data communication. Other processing systems and/or architectures may also be used, as will be clear to those skilled in the art.

System 200 may comprise one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 210. Examples of processors which may be used with system 200 include, without limitation, any of the processors (e.g., Pentium™, Core i7™, Core i9™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, any of the processors available from Nvidia Corporation of Santa Clara, California, and/or the like.

Processor(s) 210 may be connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 may comprise main memory 215. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Python, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 200 may comprise secondary memory 220. Secondary memory 220 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within system 200. The computer software stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may include an internal medium 225 and/or a removable medium 230. Internal medium 225 and removable medium 230 are read from and/or written to in any well-known manner. Internal medium 225 may comprise one or more hard disk drives, solid state drives, and/or the like. Removable storage medium 230 may be, for example, a magnetic tape drive, a compact disc (CD) drive, a digital versatile disc (DVD) drive, other optical drive, a flash memory drive, and/or the like.

System 200 may comprise an input/output (I/O) interface 235. I/O interface 235 provides an interface between one or more components of system 200 and one or more input and/or output devices. Examples of input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing systems, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch-panel display (e.g., in a smartphone, tablet computer, or other mobile device).

System 200 may comprise a communication interface 240. Communication interface 240 allows software to be transferred between system 200 and external devices, networks, or other information sources. For example, computer-executable code and/or data may be transferred to system 200 from a network server via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 240 is generally in the form of electrical communication signals 255. These signals 255 may be provided to communication interface 240 via a communication channel 250 between communication interface 240 and an external system 245. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 215 and/or secondary memory 220. Computer-executable code can also be received from an external system 245 via communication interface 240 and stored in main memory 215 and/or secondary memory 220. Such computer-executable code, when executed, enables system 200 to perform one or more of the various processes disclosed herein.

In an embodiment that is implemented using software, the software may be stored on a computer-readable medium and initially loaded into system 200 by way of removable medium 230, I/O interface 235, or communication interface 240. In such an embodiment, the software is loaded into system 200 in the form of electrical communication signals 255. The software, when executed by processor 210, may cause processor 210 to perform one or more of the various processes disclosed herein.

System 200 may optionally comprise wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, baseband system 260 decodes the signal and converts it to an analog signal. Then, the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 may be communicatively coupled with processor(s) 210, which have access to memory 215 and 220. Thus, software can be received from baseband processor 260 and stored in main memory 210 or in secondary memory 220, or executed upon receipt. Such software, when executed, can enable system 200 to perform one or more of the various processes disclosed herein.

### 3. Data Flow

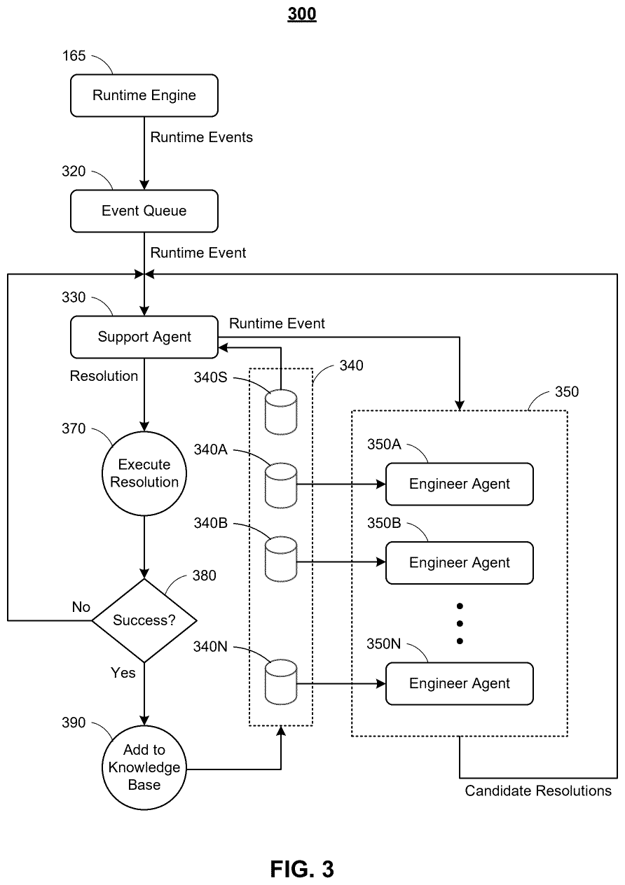

FIG. 3 illustrates an example data flow 300 for a self-correcting runtime engine 165, according to an embodiment. Data flow 300 may be implemented by server application 112 for each runtime engine 165, which comprises one or more integration processes 160 and executes in integration environment 140. The components of data flow 300 are preferably implemented as software modules, but could also be implemented as hardware modules or as modules comprising a combination of hardware and software.

As runtime engine 165 executes, one or more runtime events may be generated. For example, when an error occurs during execution of runtime engine 165, runtime engine 165 may generate an error event representing that error. An error may include the failure of an integration process 160 for any reason. Examples of errors include, without limitation, a connection error (e.g., resulting from invalid credentials, unavailability of a network resource, network timeout, expired certificates, unsupported encryption protocols, etc.), data format error (e.g., malformed data, invalid data types, schema mismatch, etc.), data transformation error (e.g., mapping error, unsupported data-type conversion, etc.), data validation error (e.g., missing required field, invalid field value, etc.), a process logic error (e.g., misconfigured step, incorrect conditional logic, infinite loop, etc.), API or web service error (e.g., HTTP error, rate limiting, invalid API requests, etc.), a database error (e.g., Structured Query Language (SQL) error, connection pool exhaustion, deadlock, etc.), a memory or resource error (e.g., out of memory, resource exhaustion, etc.), a timeout error (e.g., process timeout, connection timeout, etc.), a file system error (e.g., file not found, permission denial, file corruption, etc.), a security error (e.g., authentication failure, authorization failure, encryption issue, etc.), an unhandled exception (e.g., null pointer exception, division by zero, array index out of bounds, etc.), and/or the like. Similarly, when a warning occurs during execution of runtime engine 165, runtime engine 165 may generate a warning event representing that warning. A warning may be any issue that does not result in failure of integration process 160, but may represent a potential error. Runtime engine 165 may generate an event for any other runtime occurrence, including abnormal and/or normal occurrences, in a similar manner as for errors or warnings.

Runtime events may be added to an event queue 320, in real time, as the runtime events are generated by runtime engine 165. As used herein, the term “real time” or “real-time” contemplates events that are simultaneous, as well as events that are temporally separated from each other by ordinary latencies in processing, communication, memory access, and/or the like. All of the runtime events, generated by runtime engine 165, may be captured in event queue 320 for subsequent processing by support agent 330. Alternatively, event queue 320 may perform a gate-keeping function that ensures that only runtime events to be autonomously corrected are enqueued, to improve efficiency. This gate-keeping function may only enqueue one or more types of runtime events, such as error events, warning events, and/or other abnormal events, while excluding other types of runtime events, such as non-error events and/or normal events. The gate-keeping function may also exclude duplicate runtime events, for example, by discarding any runtime event that is identical to a runtime event generated by the same runtime engine 165 that was previously enqueued within a predefined past time window.

Event queue 320 may utilize a first-in-first-out (FIFO) queueing technique. Alternatively, event queue 320 may utilize a different queueing technique. For instance, event queue 320 could perform triage by prioritizing runtime events based on their relative severities (e.g., impacts on runtime engine 310). As an example, error events may be prioritized over warning events, such that, on average, error events are processed at a higher rate than warning events. In this case, event queue 320 may comprise a separate queue for each of a plurality of priority levels, and the queue for a higher priority level may be dequeued at a faster rate than the queue for a lower priority level. Alternatively, event queue 320 may consist of a single queue, and higher priority runtime events may be enqueued ahead of lower priority runtime events.

While only a single runtime engine 165 and a single event queue 320 are illustrated, it should be understood that data flow 300 may comprise a plurality of runtime engines 165 and/or a plurality of event queues 320. For example, a single runtime engine 165 may add all runtime events to a single dedicated event queue 320 for that runtime engine 165, a plurality of runtime engines 165 may add all runtime events to a single event queue 320 for all of the runtime engines 165, a single runtime engine 165 may distribute runtime events to a plurality of event queues 320 (e.g., for load balancing), a plurality of runtime engines 165 may distribute runtime events to a plurality of event queues 320, and/or the like, depending on the applicable design goals.

Support agent 330 may process each runtime event, one by one, from event queue 320. For example, support agent 330 may remove the runtime event at the front of event queue 330 for processing. Support engine 330 may process runtime events from a single event queue 320 or a plurality of event queues 320. While only a single support agent 330 is illustrated, it should be understood that there may be a plurality of support agents 330, executing in parallel, to each process runtime events from a single event queue 320 or a plurality of event queues 320.

In addition to or instead of event queue 320, support agent 330 may perform a gate-keeping function that ensures that only runtime events to be autonomously corrected are processed, to improve efficient. In other words, the gate-keeping function may be performed at the time of enqueuing and/or at the time of dequeuing. This gate-keeping function may only process one or more types of runtime events, such as error events, warning events, and/or other abnormal events, while discarding other types of runtime events, such as non-error events and/or normal events. The gate-keeping function may also avoid the processing of duplicate runtime events. For example, support agent 330 may compare each runtime event, removed from event queue 320, to previously processed runtime events, and discard any runtime event that is identical to a previously processed runtime event generated by the same runtime engine 165 (e.g., within a predefined past time window). Support agent 330 may also perform triage to process higher priority runtime events (e.g., having a greater impact on runtime engine 165) ahead of lower priority runtime events, for example, in an embodiment in which triage is not performed at the time of enqueuing.

Support agent 330 may process each runtime event by, firstly, determining whether or not the runtime event is associated with a known resolution in a general knowledge base 340S. Knowledge base 340S may associate prior runtime events with known resolutions for those prior runtime events. Support agent 330 may access knowledge base 340S, using an index or other representation derived from the runtime event being processed, to determine whether or not the runtime event being processed is already associated with a known resolution in knowledge base 340S.

Knowledge base 340S may be generated from a plurality of historical data. The historical data may be crowd-sourced from a plurality, and potentially all, of the integration platforms of a plurality, and potentially all, of the organizational accounts on platform 110. The historical data may associate each of a plurality of past runtime events with a successful resolution of that past runtime event.

Knowledge base 340S may comprise or consist of a database comprising known resolutions that are each indexed by a key, derivable from the past runtime event associated with that known resolution in the historical data. In this case, support agent 330 may derive the key from the runtime event being processed, and query the database using the key to retrieve one or more known resolutions to the runtime event being processed.

In a preferred embodiment, support agent 330 has a retrieval-augmented generation (RAG) architecture. The RAG architecture represents a hybrid approach that combines a retrieval-based component with a generation-based component. It is particularly effective when a response is to be informed by a large knowledge base. In this case, knowledge base 340S may comprise both a vector database, to support the retrieval-based component of support agent 330, and a generative language model, to support the generation-based component of support agent 330. The RAG architecture provides dynamic and scalable access to a knowledge base, improved generalization (e.g., enabling the generative model to respond to prompts beyond those for which the generative model was trained), and reduced model size (e.g., since the generative model does not need to store all relevant data internally). Suitable enhancements to the RAG architecture, which may be used, include Chunked RAG (CRAG), in which the retrieval-based component retrieves relevant chunks of the knowledge corpus, and Self-RAG, in which the retrieval-based component is able to retrieve relevant data from a store of prior responses, as well as the vector database. In an alternative embodiment, support agent 330 may comprise only the retrieval-based component or only the generation-based component. Other alternatives to the RAG architecture include, without limitation, LangChain, which may incorporate a RAG approach, CrewAI, and/or the like.

The vector database in knowledge base 340S, for the retrieval-based component of support agent 330, may comprise a plurality of vectors, representing the past runtime events. Each of the plurality of vectors may be associated with the known resolution to the respective past runtime event. The vector for each past runtime event may comprise or consist of an embedding vector that represents the position of the past runtime event within a multi-dimensional vector space. The multi-dimensional vector space may comprise one-hundred or more dimensions. The embedding vector for a past runtime event will comprise a value (e.g., real value) for the past runtime event, for each dimension of the vector space, with each value representing a position of the past runtime event within the respective dimension. Any suitable embedding algorithm may be used, including, without limitation, Word2Vec, Global Vectors for Word Representation (GloVe), FastText, Embeddings from Language Models (ELMo), Bidirectional Encoder Representations from Transformers (BERT), Dense Passage Retrieval (DPR), Universal Sentence Encoder (USE), or the like. Each of the plurality of embedding vectors in the vector database may be associated in knowledge base 340S with a past resolution for the past runtime event, represented by that embedding vector.

The generative language model in knowledge base 340S, for the generation-based component of support agent 330, may comprise a large language model. One well-known example of a large language model is the Generative Pre-trained Transformer (GPT). GPT-4 is the fourth-generation language prediction model in the GPT-n series, created by OpenAI™ of San Francisco, California. GPT-4 is an autoregressive language model that uses deep learning to produce human-like text. GPT-4 has been pre-trained on a vast amount of text from the open Internet. While GPT-4 is provided as an example, it should be understood that the generative language model may be any generative language model, including past and future generations of GPT, as well as other large language models, such as any of the Claude family of large language models (e.g., Claude 3 Opus) developed by Anthropic PBC of San Francisco, California, the Falcon large language model (e.g., Falcon 180B) released by the United Arab Emirates'Technology Innovation Institute (TII), the Large Language Model Meta AI (LLaMA) model (e.g., LLaMA 2) released by Meta AI of New York, New York, the Gemini model, the Mistral family of models released by Mistral AI of Paris, France, and the like. Alternatively or additionally, the generative language model may comprise or consist of a code-completion model that is trained to produce source code, data structures represented in a markup language (e.g., XML, HTML, etc.) or other format, and/or the like. A pre-trained generative language model may used as a base model that is fine-tuned for the specific task of identifying a known resolution for a runtime event.

Firstly, in the retrieval-based component, support agent 330 retrieves relevant data from the vector database of knowledge base 340S, to provide a factual grounding for the generation-based component. In particular, support agent 330 may derive a feature vector from the runtime event being processed. The feature vector is an embedding vector that represents the position of the runtime event being processed, within the same multi-dimensional vector space as the embedding vectors in the vector database. Thus, the feature vector will comprise a value (e.g., real value) for the runtime event being processed, for each dimension of the vector space, with each value representing a position of the runtime event being processed within the respective dimension. Support agent 330 may then search the vector database for one or more of the plurality of embedding vectors that match the feature vector, according to a similarity metric (e.g., the most similar embedding vector or a plurality of the most similar embedding vectors). Any suitable similarity metric may be used. As an example, the similarity metric may be a distance, such as Euclidean distance, Manhattan distance, Cosine distance, Hamming distance, Minkowski distance, Chebyshev distance, Jaccard distance, Haversine distance, Sorensen-Dice distance, or the like. The search of the vector database may be performed using any suitable technique, such as brute force, k-dimensional trees, ball trees, locality-sensitive hashing (LSH), k-nearest neighbor (kNN), approximate nearest neighbor (e.g., Facebook™ AI Similarity Search, Approximate Nearest Neighbors Oh Yeah (ANNOY), scalable nearest neighbors (ScaNN), etc.), Hierarchical Navigable Small World (HNSW) graphs, Voronoi diagrams, vector quantization, product quantization (PQ), random projection trees, lattice-based methods (e.g., cover tree, vantage point tree, etc.), and/or the like.

The search of the vector database may return the single most similar embedding vector, or a plurality of the most similar embedding vectors, as determined by the similarity metric. In an embodiment that returns a plurality of the most similar embedding vectors, the plurality of most similar embedding vectors may be a predefined number (e.g., three, five, ten, etc.) of the most similar embedding vectors, every embedding vector for which the similarity metric to the feature vector satisfies (e.g., is greater than or equal to) a predefined threshold, and/or the like. Support agent 330 may retrieve, from knowledge base 340S, the known resolution and/or other relevant data associated with each embedding vector, in the returned set of one or more embedding vectors. It should be understood that, in some cases, the vector database may return no embedding vectors (e.g., no similarity metric satisfies the predefined threshold), in which case, no relevant data are retrieved.

Secondly, in the generation-based component, support agent 330 applies a generative model of knowledge base 340S, such as a generative language model (e.g., large language model), to the retrieved relevant data, including the known resolution(s), along with a query instructing the generative model how to use the relevant data. The generative model may be fine-tuned to weight the relevant data as more important than other data (e.g., internal to the generative model). The query and relevant data may be embodied in a textual prompt. This prompt is input to the generative model to produce a response. In particular, the generative model processes the prompt to produce a contextually aware response.

Support agent 330 may generate the prompt for a generative model based on the result of the search of the vector database in the retrieval-based component. The prompt may be generated by inserting the retrieved relevant data, including each known resolution, into a predefined template. The predefined template may comprise a pre-conversation and/or post-conversation, which provide context and/or instructions for the generative model, and one or more placeholders into which the retrieved relevant data, or data derived therefrom, are inserted. The pre-conversation and/or post-conversation may define the role of the generative model, which may include instructing the generative model to determine a resolution to the runtime event being processed based on the known resolution(s) and/or other relevant data. The pre-conversation and/or post-conversation may also define an output format for the generative model (e.g., a list structure, a hierarchical structure, a markup-language structure, a resolution identifier, etc.), and/or perform other functions. The generative model may return a response that provides at least one resolution for the runtime event being processed, if such a resolution can be derived with sufficient confidence. In this case, support agent 330 may determine that the runtime event is associated with a known resolution. Otherwise, the response from the generative model may indicate that no resolution for the runtime event could be determined. In this case, support agent 330 may determine that the runtime event is not associated with a known resolution.

When support agent 330 determines that the runtime event being processed is not associated with any known resolution in knowledge base 340S (e.g., because an indication of no known resolution is returned by knowledge base 340S), support agent 330 may send a representation of the runtime event being processed to each of a plurality of engineer agents 350. In the event that support agent 330 utilizes the RAG architecture and engineer agents 350 utilize the same vector space (e.g., same embedding algorithm) as the retrieval-based component of support agent 330, the representation of the runtime event may comprise or consist of the feature vector derived from the runtime event. Alternatively, the representation of the runtime event may comprise or consist of the runtime event itself, for example, if engineer agents 350 do not utilize a vector space or utilize a different vector space (e.g., different embedding algorithm) than support agent 330. Otherwise, when support agent 330 determines that the runtime event being processed is associated with a known resolution in knowledge base 340S (e.g., because a known resolution is returned by knowledge base 340S), support agent 330 may initiate execution of the known resolution in module 370.

While only a few engineer agents 350A, 350B, . . . , and 350N are illustrated, data flow 300 may comprise any number of engineer agents 350, including one, two, three, four, five, ten, twenty, one-hundred, or more engineer agents 350. In a preferred embodiment, data flow 300 comprises a plurality of engineer agents 350, rather than a single engineer agent 350.

As used herein, a reference numeral with an appended letter will be used to refer to a specific component, whereas the same reference numeral without any appended letter will be used to refer collectively to a plurality of the component or to refer to a generic or arbitrary instance of the component. Thus, for example, the term “engineer agents 350” refers collectively to engineer agents 350A-350N, and the term “engineer agent 350” may refer to any single one of engineer agents 350A-350N.

Support agent 330 may send the representation of the runtime event being processed to every available engineer agent 350 or to a subset of available engineer agents 350. In the latter case, support agent 330 may select the subset of engineer agents 350, to which to send the representation of the runtime event, based on one or more criteria. The one or more criteria may be based on one or more attributes of the runtime event being processed (e.g., the type of runtime event, the content of runtime event, metadata of runtime event, etc.). Additionally or alternatively, the one or more criteria may be based on the response from knowledge base 340S. For instance, in an embodiment in which knowledge base 340S comprises a generative model, the response of the generative model may identify or otherwise indicate the subset of engineer agents 350 to utilize. In particular, the response could identify each engineer agent 350 to which to send the representation of the runtime event, each knowledge domain that is potentially relevant to the runtime engine, and/or the like, and support agent 330 may select a subset of available engineer agents 350 according to this response.

Each engineer agent 350 may be configured to apply a different knowledge domain to the runtime event than any other one of the engineer agents 350, to produce at least one respective candidate resolution. In other words, each engineer agent 350 is designed to analyze the runtime event according to a different knowledge domain. Every engineer agent 350 may have the same architecture, or one or more engineer agents 350 may have a different architecture than one or more other engineer agents 340. Each engineer agent 350 is associated with a respective knowledge base 340 that is specific to the respective knowledge domain of that engineer agent 350. For example, engineer agent 350A is associated with knowledge base 340A, engineer agent 350B is associated with knowledge base 340B, and engineer agent 350N is associated with knowledge base 340N.

In an embodiment, one or more, and potentially all, of engineer agents 350 have the same or similar architecture as support agent 330. For example, each engineer agent 350 may have a RAG architecture, with a retrieval-based component and a generation-based component. In this case, the knowledge base 340 associated with each engineer agent 350 may comprise both a vector database, to support the retrieval-based component of that engineer agent 350, and a generative language model, to support the generation-based component of that engineer agent 350. Each knowledge base 340 may be domain-specific and different than every other knowledge base 340 (i.e., specific to the knowledge domain of the respective engineer agent 350). In all other respects, the operation of engineer agent 350 may be identical or similar to the operation of support agent 330. Thus, the descriptions of the retrieval-based component and generation-based component of support agent 330 apply equally to the retrieval-based component and generation-based component, respectively, of each engineer agent 350 that implements the RAG architecture. Each engineer agent 350 produces at least one candidate resolution or else indicates that no candidate resolution could be determined, based on its associated domain-specific knowledge base 340. Notably, each engineer agent 350, as well as support agent 330, may have its own set of discrete tools and techniques, which can be used to analyze and troubleshoot issues within their respective area of expertise (i.e., knowledge domain).

The vector database of the domain-specific knowledge base 340, associated with an engineer agent 350, may comprise a plurality of embedding vectors for runtime events that are specific to the knowledge domain associated with that engineer agent 350. In other words, the historical data that are used to generate the vector database for a given knowledge base 340 will be relevant to the knowledge domain of the associated engineer agent 350, and will be different from the historical data used to generate the vector database for the knowledge base 340 of every other engineer agent 350. Thus, each vector database will be domain-specific and different from every other vector database.

As discussed elsewhere herein, each of the plurality of embedding vectors may represent a position of a past runtime event in a multi-dimensional vector space, which may have over one-hundred dimensions. In addition, each of the plurality of embedding vectors may be associated with a past resolution. Each engineer agent 350 may search the vector database in its respective knowledge base 340 for any of the plurality of embedding vectors that match a feature vector, derived from the runtime event being processed, according to a similarity metric (e.g., the same similarity metric as used by support agent 330). A match may be determined when the similarity metric exceeds a predefined threshold. Engineer agent 350 may then retrieve the past resolution associated with each matching embedding vector.

The generative model of the knowledge base 340, associated with an engineer agent 350, may be fine-tuned for the specific knowledge domain associated with that engineer agent 350. Thus, each generative model will be domain-specific and different from every other generative model. Each engineer agent 350 may generate a prompt based on any past resolution that was retrieved based on matched embedding vectors, if any, input this prompt to the generative model to produce a response, and determine at least one candidate resolution based on the response. It should be understood that the response may identify the candidate resolution. In an embodiment, the candidate resolution comprises or consists of the response. In an alternative embodiment, the candidate resolution is extracted or otherwise derived from the response.

As exemplary types, engineer agents 350 may comprise an integration agent that outputs candidate resolutions specific to the integration domain, a runtime agent that outputs candidate resolutions specific to the runtime domain, an infrastructure agent that outputs candidate resolutions specific to the infrastructure domain, a network agent that outputs candidate resolutions specific to the network domain, an operating-system (OS) agent that outputs candidate resolutions specific to the OS domain (e.g., Linux™), a virtual-machine (VM) agent that outputs candidate resolutions specific to the VM (e.g., Java™) domain, and/or the like. It should be understood that there may be multiple instances of each type of engineer agent 350 (i.e., representing each knowledge domain), executing in parallel, such as multiple instances of the integration agent, runtime agent, infrastructure agent, multiple instances, network agent, OS agent, VM agent, and/or the like, depending on the current demand for each type of engineer agent 350. In this case, each engineer agent 350 in the same knowledge domain may utilize the same knowledge base 340 or duplicate copies of knowledge base 340.

The integration agent may evaluate the runtime event for a resolution that involves a change to integration process 160, such as a change to a setting in the configuration of a step in integration process 160 or in the configuration of integration process 160 as a whole. Thus, the candidate resolution(s), output by the integration agent, may comprise a change to one or more settings in a configuration of an integration process 160 within runtime engine 165 (e.g., to fix an error in integration process 160).

The runtime agent may evaluate the runtime event for a resolution that involves a change to runtime engine 165, such as a change to a setting in the configuration of runtime engine 165. Thus, the candidate resolution(s), output by the runtime agent, may comprise a change to one or more settings in the configuration of runtime engine 165 (e.g., to increase resources available to integration process(es) 160 within runtime engine 165).

The infrastructure agent may evaluate the runtime event for a resolution that involves a change in the integration platform on which runtime engine 165 is executing, such as a change to a setting in the configuration of the integration platform on an iPaaS platform. Thus, the candidate resolution(s), output by the infrastructure agent, may comprise a change to one or more settings in the configuration of the integration platform (e.g., to increase resources available to runtime engine(s) 165 of the integration platform).

The network agent may evaluate the runtime event for a resolution that involves a change related to a network (e.g., network(s) 120) which integration process 160, runtime engine 165, or the integration platform uses for communications, such as a change to a setting in the configuration of network communications, troubleshooting network connectivity issues, and/or the like. Thus, the candidate resolution(s), output by the network agent, may comprise a change to one or more settings in the network configuration, the initiation of a process to troubleshoot network connectivity issues, and/or the like.

The OS agent may evaluate the runtime event for a resolution that involves a change related to the operating system (e.g., Linux™) on which the integration platform is operating, such as a change to a setting in the configuration of the operating system, troubleshooting OS issues, and/or the like. Thus, the candidate resolution(s), output by the OS agent, may comprise a change to one or more settings of the operating system (e.g., to increase available resources), the initiation of a process to troubleshoot OS issues, and/or the like.

The VM agent may evaluate the runtime event for a resolution that involves a change to the virtual machine (e.g., Java™) in which runtime engine 160 or the integration platform is executing, such as a change to a setting in the configuration of the virtual machine. Thus, the candidate resolution(s), output by the VM agent, may comprise a change to one or more settings in the configuration of the virtual machine (e.g., to increase resources available to the virtual machine).

In an embodiment, engineer agents 350 are configured to communicate with each other and/or support agent 330, if necessary, to gather additional information. In other words, engineer agents 350 may collaborate with each other to identify candidate resolution(s).

Support agent 330 may receive or collect all of the candidate resolution(s), output by all engineer agents 350 utilized by support agent 330, and select one of the candidate resolution(s) to implement. Any suitable selection mechanism may be used to select the candidate resolution. For example, support agent 330 may select the first candidate resolution to be returned by an engineer agent 350, randomly select one of the candidate resolutions that are returned, utilize logic or computation to rank the candidate resolutions and select the highest-ranked candidate resolution, apply a machine-learning model (e.g., the generative model of knowledge base 340S) to select one of the candidate resolutions, or the like. Once support agent 330 has selected one of the candidate resolution(s), support agent 330 may initiate execution of the selected resolution in module 370.

Module 370 may execute the resolution, selected by support agent 330. Executing the resolution may comprise changing one or more settings in a configuration of integration process 160, runtime engine 165, the integration platform on which runtime engine 165 is being executed, a network connection, the operating system, and/or virtual machine in which runtime engine 165 or the integration platform is executing, initiating a troubleshooting process for the network connection and/or operating system, and/or the like.

Module 370 may be comprised in support agent 330, in which case, support agent 330 executes all resolutions. Alternatively, module 370 may also be implemented by each engineer agent 350. In this alternative case, when support agent 330 determines that a known resolution exists, without needing to collaborate with engineer agents 350, support agent 330 may execute the known resolution. Otherwise, when support 330 relies on engineer agents 350 to produce candidate resolutions, the engineer agent 350 that produced the selected resolution may execute the selected resolution. In the event that the selected resolution implicates a plurality of knowledge domains, the engineer agents 350, associated with the implicated plurality of knowledge domains, may collaborate to implement the selected resolution.

In an embodiment, the AI agent implementing a resolution, whether support agent 330 or an engineer agent 350, may have limits on what actions it can do automatically when executing a resolution. These limits may be set by an operator of platform 110 or other user as a set of configurable parameters defining what the integration can and cannot do automatically. Thus, for example, the integration agent may be permitted to change the setting(s) in the configuration of certain integration processes 160, but not others, or certain types or groups of integration processes 160, but not other types or groups of integration processes 160. Similar examples may be envisioned for other types of AI agents. If an AI agent is not permitted to automatically perform an action that is required for a resolution, the AI agent may notify and/or instruct a user to perform the action manually and/or how to perform the action manually.

Module 380 may determine whether or not the runtime event being processed has been resolved. In other words, module 380 determines whether or not the resolution, executed in module 370, actually resolved the runtime event. In particular, module 380 may track the status of each runtime event for which a resolution has been executed by module 370, and monitor event queue 320 to determine whether or not the same runtime event appears again after the resolution has been executed. If the same runtime event reappears (e.g., within a predefined time period after execution of the resolution), then module 380 may determine that the resolution was unsuccessful. Otherwise, if the same runtime event does not reappear (e.g., within the predefined time period after execution of the resolution), then module 380 may determine that the resolution was successful. When determining that the resolution was unsuccessful (i.e., “No” in module 380), support agent 330 may be notified. In this case, support agent 330 may select a different one of the known or candidate resolutions (e.g., using the same or different selection mechanism), and initiate execution of the newly selected resolution in module 370. Otherwise, when determining that the resolution was successful (i.e., “Yes” in module 380), a record of the runtime event and the successful resolution may be added to knowledge base 340 in module 390.

Module 390 may associate the runtime event with the successful resolution in at least one knowledge base 340, for continual and autonomous improvement. In an embodiment that utilizes retrieval-based components, an embedding vector may be derived from the runtime event, using the same embedding algorithm discussed elsewhere herein, the embedding vector may be associated with the successful resolution, which now represents a known or past resolution, and the new embedding vector may be added to one or more knowledge bases 340. In an embodiment, the new embedding vector is added to general knowledge base 340S for support engine 330. Alternatively or additionally, the new embedding vector may be stored in the domain-specific knowledge base 340 associated with the particular engineer agent 350 that output the successful resolution. In other words, the new embedding vector may be stored in the knowledge base 340 that represents the knowledge domain of the successful resolution.

In an embodiment, support agent 330 and/or engineer agents 350 are modular components of data flow 300. In other words, an existing support agent 330 may be removed from data flow 300 and/or a new support agent 330 may be added to data flow 300, in a plug-and-play manner. Similarly, an existing engineer agent 350 may be removed from data flow 300 and/or a new engineer agent 350 may be added to data flow 300, in a plug-and-play manner. Thus, support agents 330 and/or engineer agents 350 may be easily rotated in and out of data flow 300, as needed or desired, to dynamically adapt to new issues with minimal-to-no human intervention, for an efficient, flexible, and effective data flow 300.

### 4. Process

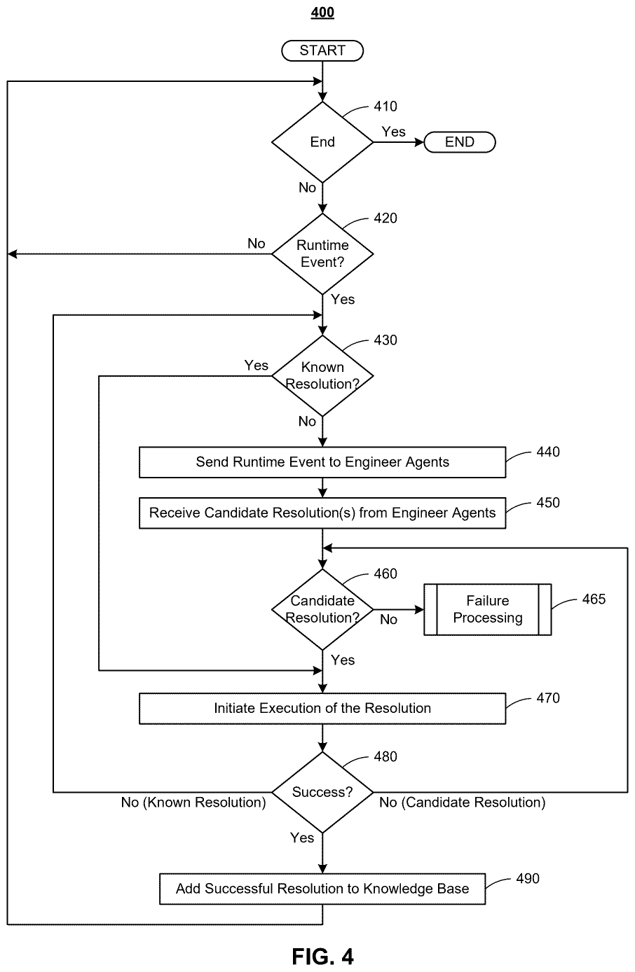

FIG. 4 illustrates an example process 400 for support agent 330, according to an embodiment. Process 400 may be implemented by support agent 330 or a set of modules that include support agent 330. While process 400 is illustrated with a certain arrangement and ordering of subprocesses, process 400 may be implemented with fewer, more, or different subprocesses and a different arrangement and/or ordering of subprocesses. Furthermore, any subprocess, which does not depend on the completion of another subprocess, may be executed before, after, or in parallel with that other independent subprocess, even if the subprocesses are described or illustrated in a particular order.

Subprocess 410 may determine whether or not to end process 400. Process 400 may continue to operate for as long as support agent 330 is running. In the event that there are a plurality of support agents 330, process 400 may execute for each support agent 330. When a support agent 330 is terminated (e.g., by a user operation, automatically in response to a decrease in demand, etc.), subprocess 410 may determine to end process 400. Conversely, when a new support agent 330 is instantiated (e.g., by a user operation, automatically in response to an increase in demand, etc.), a new process 400 may be spun up. When determining to end process 400 (i.e., “Yes” in subprocess 410), process 400 may end. Otherwise, when not determining to end process 400 (i.e., “No” in subprocess 410), process 400 may proceed to subprocess 420.

Subprocess 420 may determine whether or not a runtime event remains to be processed. In particular, subprocess 420 may determine whether or not event queue 320 is empty. When event queue 320 is empty, there are no more runtime events to process. Conversely, when event queue 320 is not empty, there is at least one more runtime event to process. Subprocess 420 may comprise a gate-keeping function, as described elsewhere herein, to prevent the processing of duplicate or other unnecessary runtime events. When determining that no more runtime events remain to be processed (i.e., “No” in subprocess 420), process 400 may return to subprocess 410 to await either the end of process 400 or the addition of a new runtime event to event queue 320. Otherwise, when determining that another runtime event remains to be processed (i.e., “Yes” in subprocess 420), process 400 may remove the runtime event at the front of event queue 320, and proceed to subprocess 430 to begin processing the removed runtime event. It should be understood that the subsequent subprocesses 430-490 may be performed for each of a plurality of runtime events, in event queue 320, in real time (i.e., as those runtime events are queued), for at least one runtime engine 165.

Subprocess 430 may determine whether or not there is a known resolution to the runtime event being processed. In particular, as discussed elsewhere herein, support agent 330 may determine whether or not the runtime event is associated with a known resolution in general knowledge base 340S. In a preferred embodiment, support agent 330 utilizes a RAG architecture to retrieve relevant data, including one or more known resolutions, based on a feature vector of the runtime event, construct a textual prompt using the relevant data, and input the prompt to a generative model to produce either one or more known resolutions or an indication that there is no known resolution. When determining that there is no known resolution (i.e., “No” in subprocess 430), process 400 may proceed to subprocess 440. Otherwise, when determining that there is a known resolution (i.e., “Yes” in subprocess 430), process 400 may proceed to subprocess 470. In some cases, knowledge base 340S may return a plurality of known solutions. In this case, subprocess 430 may select one of the plurality of known solutions using any suitable selection mechanism, as discussed elsewhere herein, before proceeding to subprocess 470.

Subprocess 440 may send the runtime event being processed to each of a plurality of engineer agents 350. Subprocess 440 may send the runtime event to all available engineer agents 350 or a subset of all available engineer agents 350 (e.g., as determined by the generative model of knowledge base 340S). As discussed elsewhere herein, each of the plurality of engineer agents 350 may be configured to apply a different knowledge domain to the runtime event than any other one of the plurality of engineer agents 350, to produce at least one candidate resolution, if possible. In a preferred embodiment, each engineer agent 350 utilizes a RAG architecture to retrieve relevant data, including one or more potential resolutions, based on a feature vector of the runtime event, construct a textual prompt using the relevant data, and input the prompt to a generative model to produce either one or more candidate resolutions or an indication that there is no candidate resolution.

Subprocess 450 may receive candidate resolution(s) from the plurality of engineer agents 350 to which the runtime event was sent. It should be understood that any given engineer agent 350 may return a single candidate resolution, a plurality of candidate resolutions, or no candidate resolutions. Subprocess 450 may wait for all engineer agents 350, to which the runtime event was sent, to respond before proceeding to subprocess 460. Alternatively, subprocess 450 may wait a predefined time duration for engineer agents 350 to respond or wait for a predefined number of engineer agents 350 to respond, and then proceed to subprocess 460.

Triggered subsets of subprocesses 460-480 may performed in each of one or more iterations until a successful resolution is found. At a high level, each iteration selects and tests one of the candidate resolutions received in subprocess 450. When the tested candidate resolution is determined to not resolve the runtime event being processed, another iteration may be added. Conversely, when the tested candidate resolution is determined to resolve the runtime event being processed, the iteration(s) may end. Accordingly, there may be one or a plurality of iterations needed before a successful resolution is found.

Subprocess 460 may determine whether or not at least one candidate resolution remains to be considered. When determining that no candidate resolution remains to be considered (i.e., “No” in subprocess 460), process 400 may proceed to failure processing in subprocess 465. In this case, process 400 was unable to automatically resolve the runtime event. Conversely, when determining that at least one candidate resolution remains to be considered (i.e., “Yes” in subprocess 460), subprocess 460 may select the next candidate resolution using any suitable selection mechanism, as discussed elsewhere herein, before proceeding to subprocess 470.

Subprocess 465 may escalate the runtime event to another process, which may notify a user and/or perform another remedial action. In an embodiment in which a user is notified, the user may be prompted to provide guidance as to how to resolve the runtime event, or instructed to manually resolve the runtime event. Alternatively, another autonomous process may be initiated to try to automatically resolve the runtime event.

Subprocess 470 may initiate execution of the selected resolution, which may be the known resolution selected in subprocess 430 or the candidate resolution selected in subprocess 460. It should be understood that subprocess 470 corresponds to module 370. In particular, module 370 implements subprocess 470. Thus, the description of module 370 applies equally to subprocess 470. The actual execution of the selected resolution may be performed by support agent 330 (e.g., if a known resolution is being executed), the engineer agent 350 that provided the candidate resolution (e.g., if a candidate resolution is being executed), or a collaboration of support agent 330 and/or engineer agent(s) 350 (e.g., if multiple knowledge domains are implicated by the resolution being executed).

Subprocess 480 may determine whether or not the resolution, executed in subprocess 480, successfully resolved the runtime event being processed. It should be understood that subprocess 480 corresponds to module 380. In particular, module 380 implements subprocess 480. Thus, the description of module 380 applies equally to subprocess 480. For example, subprocess 480 may monitor event queue 320 to determine whether or not the same runtime event reappears. When the same runtime event does not reappear (e.g., within a predefined time window), subprocess 480 may determine that the resolution resolved the runtime event (i.e., was successful), and when the same runtime event does reappear (e.g., within the predefine time window), subprocess 480 may determine that the resolution did not resolve the runtime event (i.e., was unsuccessful). When determining that resolution resolved the runtime event (i.e., “Yes” in subprocess 480), process 400 may proceed to subprocess 490. Otherwise, when determining that the resolution did not resolve the runtime event and the resolution was a known resolution selected in subprocess 430 (i.e., “No (Known Resolution)” in subprocess 480), process 400 may return to subprocess 430 to select another known resolution, if any, or else initiate communication with engineer agents 350. On the other hand, when determining that the resolution did not resolve the runtime event and the resolution was a candidate resolution selected in subprocess 460 (i.e., “No (Candidate Resolution)” in subprocess 480), process 400 may return to subprocess 460 to select another candidate resolution, if any, or else proceed to subprocess 465 for failure processing.

Subprocess 490 may add the successful resolution to at least one knowledge base 340. It should be understood that subprocess 490 corresponds to module 390. Thus, the description of module 390 applies equally to subprocess 490. In particular, when subprocess 480 has determined that the executed resolution resolved the runtime event, an association between the runtime event and the executed resolution may be added to knowledge base 340, including general knowledge base 340S and/or the domain-specific knowledge base 340 associated the particular engineer agent 350 that output the successful resolution (i.e., representing the knowledge domain of the resolution).

Notably, no human intervention may be required during autonomous process 400. Human involvement may be limited to defining the operational limits of process 400 (e.g., of support agent 330 and/or engineer agents 350), and, in some cases, providing input to failure processing 465. In an embodiment, if the execution of a resolution, initiated in subprocess 470 by module 370, represents a significant change or would have a significant impact on runtime engine 165, a warning may be issued and/or user confirmation may be required to proceed with the execution of the resolution. If the warning is disregarded or the user confirms the change, the resolution may then be executed. Conversely, if the user declines the change, the resolution will not be executed.

In an embodiment, an audit record may be added to an audit log for each action by support agent 330 and/or engineer agents 350. The audit log provides an audit trail that enables a user or system to monitor, review, analyze, and/or confirm the actions produced by process 400. This may be useful in the case that a problem occurs (e.g., to trace the origin of the problem), for regulatory compliance, and/or the like.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of,” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to, by a support agent, for each of a plurality of runtime events, in an event queue, for at least one runtime engine, in real time:
determine that the runtime event is not associated with a known resolution in a knowledge base;
send a representation of the runtime event to each of a plurality of engineer agents, wherein each of the plurality of engineer agents is configured to apply a different knowledge domain to the runtime event than any other one of the plurality of engineer agents, to produce a candidate resolution;
receive the candidate resolutions from the plurality of engineer agents; and
in each of one or more iterations,
select one resolution from the candidate resolutions,
initiate execution of the selected resolution,
determine whether or not the executed resolution resolved the runtime event,
when determining that the executed resolution did not resolve the runtime event, add another iteration to the one or more iterations, and
when determining that the executed resolution resolved the runtime event, add an association between the executed resolution and the runtime event to the knowledge base, and end the one or more iterations.

2. The method of claim 1, wherein the knowledge base comprises a vector database, wherein the vector database comprises a plurality of embedding vectors, and wherein each of the plurality of embedding vectors represents a position of a past runtime event in a multi-dimensional vector space.

3. The method of claim 2, wherein each of the plurality of embedding vectors is associated with a past resolution.

4. The method of claim 2, wherein determining that the runtime event is not associated with a known resolution in the knowledge base comprises:
deriving a feature vector from the runtime event; and
searching the vector database for one or more of the plurality of embedding vectors that match the feature vector according to a similarity metric.

5. The method of claim 4, wherein the knowledge base further comprises a generative model, and wherein determining that the runtime event is not associated with a known resolution in the knowledge base further comprises:
generating a prompt based on a result of the search of the vector database;
inputting the prompt to the generative model to produce a response; and
determining that the runtime event is not associated with a known resolution based on the response.

6. The method of claim 1, wherein each of one or more of the plurality of engineer agents is associated with a domain-specific knowledge base that is specific to the knowledge domain of that engineer agent, and wherein each of the one or more engineer agents produces the candidate resolution based on the domain-specific knowledge base.

7. The method of claim 6, wherein the domain-specific knowledge base associated with each of the one or more engineer agents comprises a vector database, wherein the vector database comprises a plurality of embedding vectors, and wherein each of the plurality of embedding vectors represents a position of a past runtime event in a multi-dimensional vector space.

8. The method of claim 7, wherein each of the plurality of embedding vectors is associated with a past resolution.

9. The method of claim 8, wherein producing the candidate resolution comprises:
searching the vector database for one or more of the plurality of embedding vectors that match a feature vector, derived from the runtime event, according to a similarity metric; and
retrieving the past resolution associated with each matching one of the plurality of embedding vectors.

10. The method of claim 9, wherein the domain-specific knowledge base associated with each of the one or more engineer agents further comprises a generative model, and wherein producing the candidate resolution further comprises:
generating a prompt based on any past resolution that was retrieved;
inputting the prompt to the generative model to produce a response; and
determining the candidate resolution based on the response.

11. The method of claim 10, wherein the generative model, in the domain-specific knowledge base associated with each of the one or more engineer agents, has been fine-tuned for the knowledge domain of that engineer agent.

12. The method of claim 10, wherein the response identifies the candidate resolution.

13. The method of claim 6, wherein the knowledge base comprises a general knowledge base that is separate from each domain-specific knowledge base, and wherein determining that the runtime event is not associated with the known resolution in the knowledge base consists of determining that the runtime event is not associated with the known resolution in the general knowledge base.

14. The method of claim 13, wherein adding the association between the executed resolution and the runtime event to the knowledge base comprises adding the association to the general knowledge base.

15. The method of claim 13, wherein adding the association between the executed resolution and the runtime event to the knowledge base comprises adding the association to the domain-specific knowledge base associated with engineer agent that produced the candidate resolution that was selected for execution.

16. The method of claim 1, wherein the support agent executes the selected resolution.

17. The method of claim 1, wherein the engineer agent, that produced the candidate resolution that was selected, executes the selected resolution.

18. The method of claim 1, wherein the one or more iterations are a plurality of iterations.

19. A system comprising:
at least one hardware processor; and
software that is configured to, when executed by the at least one hardware processor, to execute a support agent to, for each of a plurality of runtime events, in an event queue, for at least one runtime engine, in real time,
determine that the runtime event is not associated with a known resolution in a knowledge base,
send a representation of the runtime event to each of a plurality of engineer agents, wherein each of the plurality of engineer agents is configured to apply a different knowledge domain to the runtime event than any other one of the plurality of engineer agents, to produce a candidate resolution,
receive the candidate resolutions from the plurality of engineer agents, and
in each of one or more iterations,
select one resolution from the candidate resolutions,
initiate execution of the selected resolution,
determine whether or not the executed resolution resolved the runtime event,
when determining that the executed resolution did not resolve the runtime event, add another iteration to the one or more iterations, and
when determining that the executed resolution resolved the runtime event, add an association between the executed resolution and the runtime event to the knowledge base, and end the one or more iterations.

20. A non-transitory computer-readable medium having instructions stored therein, wherein the instructions, when executed by a processor, cause the processor to execute a support agent to, for each of a plurality of runtime events, in an event queue, for at least one runtime engine, in real time:
determine that the runtime event is not associated with a known resolution in a knowledge base;
send a representation of the runtime event to each of a plurality of engineer agents, wherein each of the plurality of engineer agents is configured to apply a different knowledge domain to the runtime event than any other one of the plurality of engineer agents, to produce a candidate resolution;
receive the candidate resolutions from the plurality of engineer agents; and
in each of one or more iterations,
select one resolution from the candidate resolutions,
initiate execution of the selected resolution,
determine whether or not the executed resolution resolved the runtime event,
when determining that the executed resolution did not resolve the runtime event, add another iteration to the one or more iterations, and
when determining that the executed resolution resolved the runtime event, add an association between the executed resolution and the runtime event to the knowledge base, and end the one or more iterations.
